(19) United States
(12) Patent Application Publication
(10) Pub. No.: US 2012/0327109 A1
(43) Pub. Date: Dec. 27, 2012

(54) Method For Displaying Contacts In Instant Messenger And Instant Messaging Client

(75) Inventors: Min REN, Shenzhen City (CN); Qiang ZHANG, Shenzhen City (CN)

(73) Assignee: TENCENT TECHNOLOGY (SHENZHEN) COMPANY LIMITED, Shenzhen City (CN)

(21) Appl. No.: 13/604,221

(22) Filed: Sep. 5, 2012

Related U.S. Application Data
(63) Continuation of application No. PCT/CN2011/071292, filed on Feb. 25, 2011.

(30) Foreign Application Priority Data
Jun. 2, 2010 (CN) 201010197645.0

(51) Int. Cl. G09G 5/00

(52) U.S. Cl. 345/619

(57) ABSTRACT

A method for displaying contacts in an instant messenger. The method includes displaying information of the contacts in the form of cards in a container; responding to an event that a card is selected; and highlighting the selected card on a surface layer of the container. An instant messaging client is also provided.

### CROSS-REFERENCE TO RELATED APPLICATIONS

This application is a continuation of International Application No. PCT/CN2011/071292, filed on Feb. 25, 2011. This application claims the benefit and priority of Chinese Patent Application No. 201010197645.0, filed Jun. 2, 2012. The entire disclosures of each of the above applications are incorporated herein by reference.

### FIELD

The present disclosure relates to computer technology applications and to display contacts in an instant messenger and an instant messaging client.

### BACKGROUND

This section provides background information related to the present disclosure which is not necessarily prior art.

Network instant messaging tools developed up until now have been accepted by the majority of internet users, and become essential software tools in people work and lives, and have been widely used not only in the usual leisure entertainment but also in users' work. Thus, users put forward high requirements for personalized settings, usability, stability, security, and other aspects of the instant messaging software.

In the traditional instant messaging software, when a user moves the mouse to click an image icon of one contact in the container, the image icon of the contact is in selected state, and the highlighted way is adopted to show selection and display the image icon of the contact, to distinguish the selected icon from image icons of non-selected contacts. However, the effect of this displaying mode has a single effect, no layering, and cannot meet personalized business experience of the user.

### SUMMARY

This section provides a general summary of the disclosure, and is not a comprehensive disclosure of its full scope or all of its features.

The subject disclosure provides a method for displaying contacts in instant messenger, so that the displayed contact has an effect of layering.

The subject disclosure provides an instant messaging client so that the displayed contact has an effect of layering.

In order to achieve the above purpose, the present disclosure provides a method for displaying contacts in instant messenger, which includes:
displaying information of the contacts in the form of cards in a container;
responding to an event that a card is selected; and
highlighting the selected card on a surface layer of the container.

The highlighting the selected card on a surface layer of the container comprises at least one of:
changing light beam on a surface of the selected card;
magnifying the selected card according to a predefined magnification; or
highlighting the selected card on the surface layer of the container, and adding a shadow layer to the surface layer of the container.

After the step of highlighting the selected card on a surface layer of the container, the method further comprises: responding to an event of moving the card, calculating a displacement of the card's movement, and moving the card according to the displacement.

The method further comprises recording a height of the card, a width of the card, a rotation angle relative to a center of the card, and coordinates of the center of the card in the container.

The calculating a displacement of the card's movement is: obtaining and recording coordinates of a selected point of the card before and after the card is moved, and calculating the displacement of the card's movement according to the coordinates of the selected point of the card before and after the card is moved.

After the moving the card, the method further comprises: obtaining coordinates of a center of the card before the card is moved, and calculating and recording coordinates of the center of the card after the card is moved according to the coordinates of the selected point of the card before and after the card is moved as well as the coordinates of the center of the card before the card is moved.

The method further comprises responding to an event of rotating the card, calculating a rotation angle, and rotating the selected card according to the rotation angle.

An instant messaging client comprises:
a display module configured to display information of contacts in the form of cards in a container;
an event response module configured to respond an event that a card is selected; and
a processing module configured to process the selected card to highlight the selected card on a surface layer of the container which is displayed through the display module.

The processing module is further configured to change light beam on a surface of the selected card, and/or magnify the selected card according to a predefined magnification, and/or highlight the selected card on the surface layer of the container and add a shadow layer to the surface layer of the container.

The event response module is further configured to respond to an event of moving the card, the processing module calculates a displacement of the card's movement and moves the card according to the displacement.

The instant messaging client further comprises a recording module configured to record a height of the card, a width of the card, a rotation angle relative to a center of the card, and coordinates of the center of the card in the container.

The processing module is further configured to obtain coordinates of a selected point of the card before and after the card is moved, and calculates the displacement of the card's movement and coordinates of the center of the card after the card is moved according to the coordinates of the selected point of the card before and after the card is moved.

The recording module is further configured to record the coordinates of the selected point of the card before and after the card is moved as well as the coordinates of the center of the card before the card is moved.

The event response module is also configured to respond to an event of rotating the card, the processing module calculates a rotation angle and rotates the selected card according to the rotation angle.

The above method for displaying contacts in the instant messenger and the instant messaging client, uses displaying information of contacts in the form of cards in the container and then obtaining event that a card is selected and highlighting the selected card on the surface layer of the container, to enable the selected card to be displayed in layers. Enabling the selected contact in the instant messenger to be displayed in layers, can meet personalized business experience of the user.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

In order to more clearly illustrate various embodiments, the figures which are needed to be used in the description of the embodiments will be briefly described in the following. Obviously, the figures in the following description are only some embodiments, and it is easy for one skilled in the art to obtain other figures based on the following figures without creative work.

FIG. 1 is a flow chart of a method for displaying contacts in an instant messenger of various embodiments;

FIG. 2 is a specific flow chart of highlighting a card on a surface layer of a container of various embodiments;

FIG. 3 is a schematic effect diagram of highlighting a card on a surface layer of a container of various embodiments;

FIG. 4 is a flow chart of a method for displaying contacts in an instant messenger of various embodiments;

FIG. 5 is a schematic effect diagram of rotating a card of various embodiments;

FIG. 6 is a schematic effect diagram of cards placed in the container of various embodiments;

FIG. 7 is a schematic diagram of an instant messaging client of various embodiments; and

FIG. 8 is a schematic diagram of an instant messaging client of various embodiments.

Corresponding reference numerals indicate corresponding parts throughout the several views of the drawings.

### DETAILED DESCRIPTION

To make the above objectives, technical solution and advantages more clear, example embodiments will now be described in detail with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

A card is a combination control, and includes images, vector graphics, text and other controls, and the card can display contact information such as contact's avatar, nickname, and so on. A container is configured to place all the cards, for example, when all the cards are placed on a desktop, then the desktop is a container. The card control includes Width, Height, Angle, CenterX, CenterY properties, which represent height of the card, width of the card, rotation angle relative to a card center, x-coordinate and Y-coordinate of the card center in the container. A position of the card control in the container can be uniquely determined through Width, Height, Angle, CenterX and CenterY properties of the card.

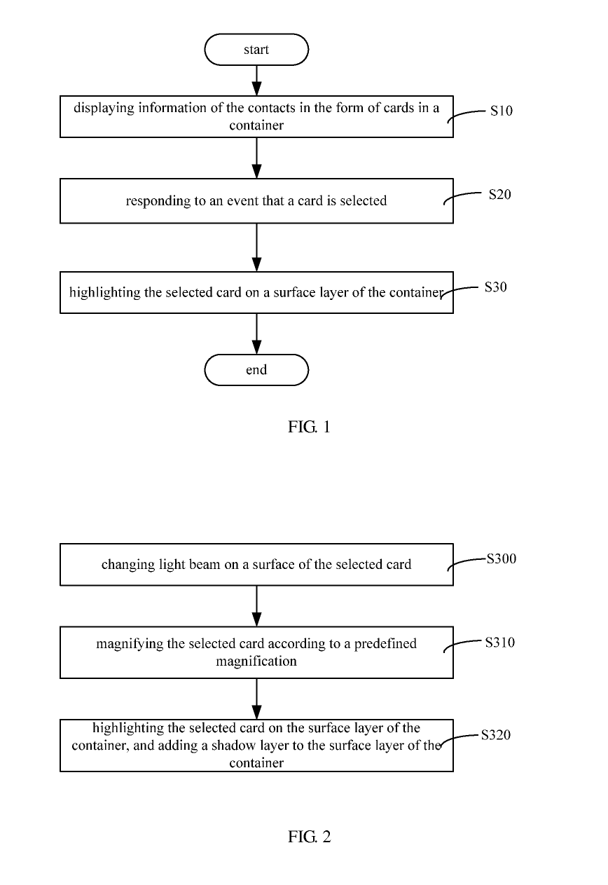

FIG. 1 is a flow chart of a method for displaying contacts in an instant messenger according to various embodiments. In FIG. 1, a method for displaying contacts in an instant messenger of one implementation, includes the following:

At S10: displaying information of contacts in the form of cards in a container.

In S10, the information of the contacts can be set in the cards in advance, for example, contact's avatar, nickname, and so on, can be set in the cards and be displayed in the form of cards. Width, Height, Angle, CenterX, CenterY properties of the cards can be set in advance. In actual applications, the Width and Height properties of the cards can adopt uniform template, i.e., various cards in the container adopt uniform specifications, and their placement angles and positions in the container can be determined according to users' needs.

At S20: responding to an event that a card is selected.

In S20, a user clicks a card displayed in the container through touching or scrolling mouse or pressing keys, thereby triggering to set the card in selected state. For example, a card containing the nickname “jack” is clicked and selected by the user, then the back end can respond to the event of selecting the “jack” card and set and display the card in selected state.

At S30: highlighting the selected card on a surface layer of the container.

In S30, responding to the event that a card is selected, if the card is selected, the selected card is highlighted from the container where the cards are placed, to distinguish from other non-selected cards.

In various embodiments, the selected card can be highlighted on a surface layer of the container where the cards are placed, and in the highlighting process of the selected card, 3D highlight effect can be stimulated by using the three factors: highlight, magnification and shadows in the 2D scene of the container, as shown in FIG. 2. FIG. 2 is a flow chart highlighting a card on a surface layer of a container of one embodiment, and the process can specifically include following:

At S300: changing light beam on a surface of the selected card.

In S300, in the highlighting process of the selected card, the highlight layer processing is adopted to cause the light beam on the surface of the selected card to change, i.e., highlight animation process. In an embodiment, the highlight layer can be a layer of which the middle is white and two sides are transparent color; in the highlighting process of the card, white highlight moves from upper left to lower right. In actual various applications, the highlight layer can be set according to the individualized needs of the user, and different highlight animation effects can be set in the highlighting process of the card.

At S310: magnifying the selected card according to a predefined magnification.

In S310, when highlighting the selected card, the card can be magnified properly according to the perspective law of near-large and far-small, i.e., magnified according to the predefined magnification. The predefined magnification relates to highlighted height of the card, i.e., magnification animation process. In an embodiment, the magnification of the card is 1.1 after being highlighted, and matches the highlighted height of the card to appear more realistic.

At S320: highlighting the selected card on the surface layer of the container, and adding a shadow layer to the surface layer of the container.

In S320, the selected card is set to be highlighted on the surface layer of the container, and the shadow of the card is set to appear on the container when the selected card moves away from the surface of the container, that is to add the shadow layer, i.e., performing shadow animation process. In an embodiment, the shadow layer is defaulted to overlap with the content of the card, when the card is clicked, the color of the shadow becomes lighter and the shadow layer can move according to a position of a preset light source. If the light source is at the upper left of the container, then the shadow moves towards the lower right of the container.

It should be noted that there is no sequence among S300, S310 and S320, and at least one process will be able to highlight the card, and a combination of the three processes is preferred.

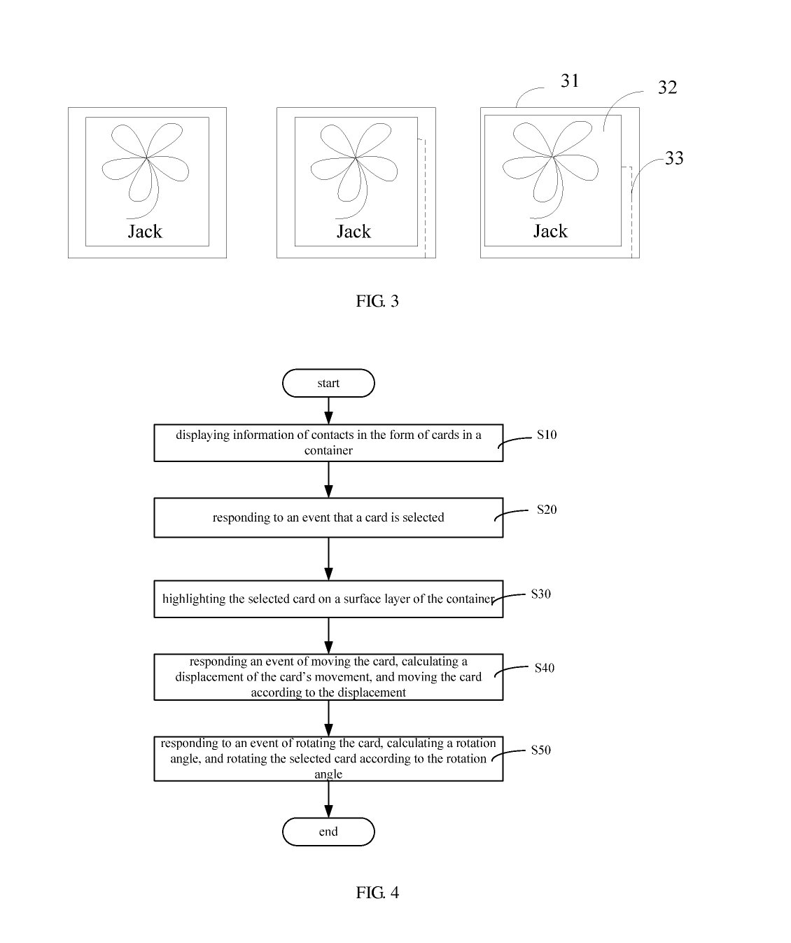

When the user clicks the selected card through touching or key-press or mouse, the highlight animation, the magnification animation and the shadow animation can be played at the same time, to realize that the card is highlighted on the surface layer of the container. A schematic effect diagram of highlighting a card on a surface layer of a container of various embodiments is shown in FIG. 3, the number 31 denotes a container, the number 32 denotes a card, the number 33 denotes a shadow layer, the change process of highlighting the card can be seen: the card 32 is magnified and the shadow layer 33 moves downward. When the user moves the mouse or key-press or touching away from the selected card, reverse animations of the above highlight animation, magnification animation and shadow animation will be played, to cause the card which is highlighted and changed to restore original unselected display state, i.e., placing the card in the container. In actual applications, when a user touches a plurality of cards at the same time, the plurality of cards is highlighted together.

In various embodiments, as shown in FIG. 4, the above method for displaying contacts in the instant messenger can also include:

At S40: responding to an event of moving the card, calculating a displacement of the card's movement, and moving the card according to the displacement.

In S40, after the card is selected, the user drags the card to move through the mouse or finger touch; the instant messenger responds to the event that the card is moved, and calculates a displacement which is required by the card's movement according to an initial position of the mouse or the finger touch and a final position of the mouse or the finger touch after dragging the card, and moves the card to a corresponding position according to the displacement.

In various embodiments, recording a height of the card, a width of the card, rotation angle relative to a card center, coordinates of the card center in the container is also included.

The specific processes of the above moving the card include: obtaining and recording coordinates of a selected point of the card before and after the card is moved, and calculating the displacement of the card's movement according to the coordinates of the selected point of the card before and after the card is moved.

After the card is moved, a step of obtaining coordinates of a center of the card before the card is moved, and calculating and recording coordinates of the center of the card after the card is moved according to the coordinates of the selected point of the card before and after the card is moved as well as the coordinates of the center of the card before the card is moved, is also included. It specifically includes: when the user selects a card through the mouse or the finger touch, a stay point of the mouse or the finger on the card is the selected point of the card; when the card is triggered to be moved, position coordinates (X0, Y0) of the mouse or the finger at this moment, i.e., the coordinates of the selected point of the card before being moved, are recorded; the coordinates of the center of the card on the container before being moved include x-coordinate and Y-coordinate (CenterX, CenterY); after the mouse and the finger moves, current position coordinates (X1, Y1) of the mouse or the finger after the card is moved, i.e., the coordinates of the selected point of the card after being moved, are recorded; the coordinates including x-coordinate and Y-coordinate of the center of the card after the card is moved, are calculated according to the coordinates (X0, Y0) of the selected point of the card before the card is moved, the coordinates (X1, Y1) of the selected point of the card after the card is moved as well as the coordinates of the center of the card before the card is moved, the calculation formula is:

CenterX=CenterX+X1−X0;

CenterY=CenterY+Y1−Y0.

At S50: responding to an event of rotating the selected card, calculating a rotation angle, and rotating the selected card according to the rotation angle.

S50 can be set to be after or before S40. When the user uses multi-touch gestures, the rotation angle alpha can be calculated by using functions of a multi-touch library, then the angle property of the card turns into Angel=Angel+alpha. A schematic effect diagram of rotating a card is shown in FIG. 5, the number 1 denotes a state of the card before being rotated, the number 2 and 3 denotes states of the card after being clockwise rotated, the states of the card rotated to different positions (rotating different angles) can be seen from this.

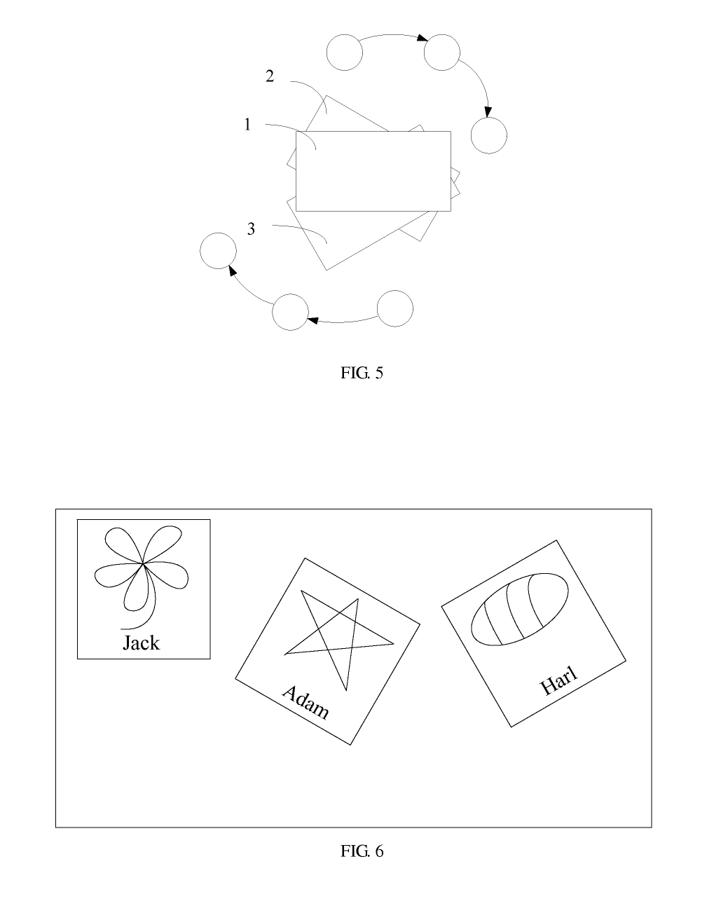

The above method for displaying contacts in the instant messenger, uses highlighting the selected card on the surface layer of the container and moving the card from the surface layer of the container when displaying the selected card and the container, to enable the selected card to be displayed in layers. Further, in the highlighting process of the card, with different card styles and backgrounds of the container, different texture effects can be realized. A schematic effect diagram of cards placed in the container is shown in FIG. 6, a situation of the cards being displayed in the container can be seen.

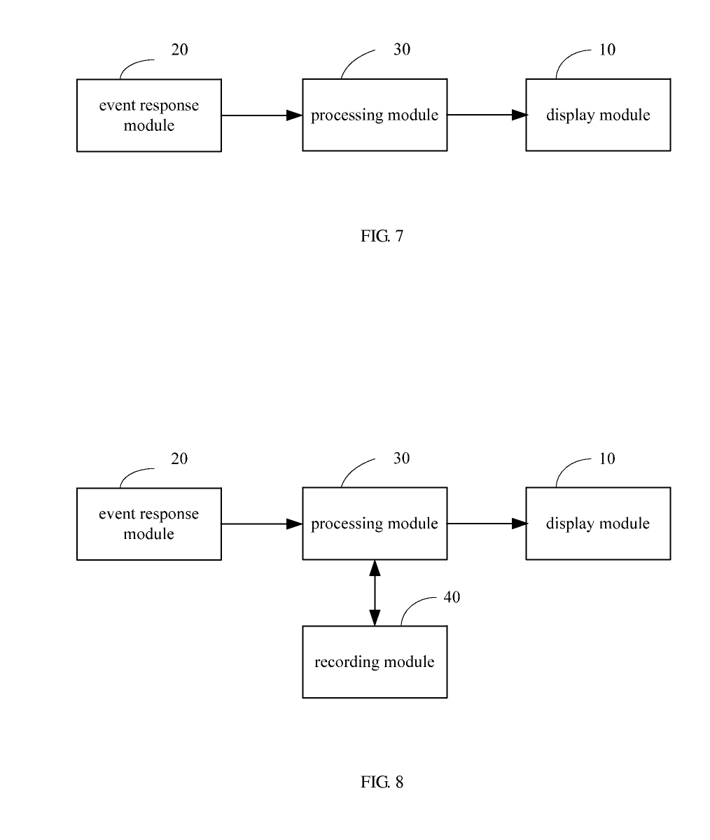

As shown in FIG. 7, in various embodiments, an instant messaging client includes a display module 10, an event response module 20 and a processing module 30.

The display module 10 is configured to display information of contacts in the form of cards in a container. The display module 10 can set the information of the contacts in the cards, for example, contact's avatar, nickname, and so on, can be set in the cards and be displayed in the form of cards.

The event response module 20 is configured to obtain an event that a card is selected. The event response module 20 obtains an event that a user clicks the card through touching or scrolling mouse or pressing keys, then sets the card in selected state. For example, a card containing the nickname “jack” is clicked and selected by the user, then the back end can respond the event of selecting the “jack” card and set and display the card in selected state.

The processing module 30 is configured to process the selected card, to highlight the selected card on the surface layer of the container which is displayed through the display module 10. After the event response module 20 obtains an event of selecting a card, the card is selected, the processing module 30 highlights the selected card from the container where the cards are placed, to distinguish it from other non-selected cards. In various embodiments, the selected card can be highlighted on a surface layer of the container, the processing module 30 uses the three factors: highlight, magnification and shadows in the 2D scene of the container to stimulate 3D highlight effect. The specific process processed by the processing module 30 includes:

(1) changing light beam on the surface of the selected card. In the highlighting process of the selected card, the highlight layer processing is adopted to cause the light beam on the surface of the selected card to be changed according to predefined configurations, i.e., highlight animation process. In an embodiment, the highlight layer can be a layer of which the middle is white and two sides are transparent color. In the highlighting process of the card, white highlight moves from upper left to lower right.

(2) magnifying the selected card according to a predefined magnification. When highlighting the selected card, the card can be magnified properly according to the perspective law of near-large and far-small, the processing module 30 magnifies the card according to the predefined magnification, and the predefined magnification relates to highlighted height of the card, i.e., magnification animation process. In an embodiment, the magnification of the card is 1.1 after being highlighted, and matches the highlighted height of the card to appear more realistic.

(3) highlighting the selected card on the surface layer of the container, and adding a shadow layer to the surface layer of the container. The selected card is set to be highlighted on the surface layer of the container, and the shadow of the card is set to appear on the container when the selected card moves away from the surface of the container, that is to add the shadow layer, i.e., shadow animation process. In an embodiment, the shadow layer is defaulted to overlap with the content of the card, when the card is clicked, the color of the shadow layer becomes lighter and the shadow layer can move according to a position of a light source. If the light source is at the upper left of the container, then the shadow moves towards the lower right of the container.

When the user clicks the selected card through touching or key-press or mouse, the processing module 30 can play the highlight animation, the magnification animation and the shadow animation at the same time, to realize that the card is highlighted on the surface layer of the container; when the user moves the mouse or key-press or touching away from the selected card, the processing module 30 will play reverse animations of the above animations, to cause the card to restore original unselected display state, i.e., placing the card in the container. When the user touch a plurality of cards at the same time, the processing module 30 processes the plurality of cards and the plurality of cards are highlighted together.

In various embodiments, as shown in FIG. 8, the above instant messaging client further includes a recording module 40 configured to record a height of the card, a width of the card, a rotation angle relative to the card center, and coordinates of the card center in the container.

The event response module 20 is further configured to respond an event of moving the card. The processing module 30 is further configured to calculate a displacement of the card's movement and move the card according to the displacement.

After the card is selected, the user drags the card to move through the mouse or finger touch. In an embodiment, the processing module 30 is further configured to obtain coordinates of a selected point of the card before and after the card is moved, and calculate the displacement of the card's movement according to the coordinates of the selected point of the card before and after the card is moved. After the processing module 30 moves the card, the processing module 30 is further configured to obtain coordinates of a center of the card before the card is moved, and calculate coordinates of the center of the card after the card is moved according to the coordinates of the selected point of the card before and after the card is moved as well as the coordinates of the center of the card before the card is moved.

The recording module 40 is further configured to record the coordinates of the selected point of the card before and after the card is moved as well as the coordinates of the center of the card before and after the card is moved. It specifically is:

when the user selects a card through the mouse or the finger touch, a stay point of the mouse or the finger on the card is the selected point of the card. When the card is moved, position coordinates (X0, Y0) of the mouse or the finger at this moment, i.e., the coordinates of the selected point of the card before being moved, are recorded. The coordinates of the center of the card on the container before being moved include x-coordinate and Y-coordinate (CenterX, CenterY). After the mouse and the finger moves, current position coordinates (X1, Y1) of the mouse or the finger after the card is moved, i.e., the coordinates of the selected point of the card after being moved, are recorded; the coordinates including x-coordinate and Y-coordinate of the center of the card after the card is moved, are calculated according to the coordinates (X0, Y0) of the selected point of the card before the card is moved, the coordinates (X1, Y1) of the selected point of the card after the card is moved as well as the coordinates of the center of the card before the card is moved, the calculation formula is:

CenterX=CenterX+X1−X0;

CenterY=CenterY+Y1−Y0.

In an embodiment, the event responding module 20 is further configured to respond to an event of rotating a card. The processing module 30 is configured to calculate a rotation angle and rotate the selected card according to the rotation angle. When the user uses multi-touch gestures, the processing module 30 can use functions of a multi-touch library to calculate the rotation angle alpha, then the angle property of the card turns into Angel=Angel+alpha.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for displaying contacts in an instant messenger, comprising following steps:
displaying information of the contacts in the form of cards in a container;
responding to an event that a card is selected; and
highlighting the selected card on a surface layer of the container.

2. The method according to claim 1, wherein the step of highlighting the selected card on a surface layer of the container comprises at least one of following steps:
changing light beam on a surface of the selected card;
magnifying the selected card according to a predefined magnification;
highlighting the selected card on the surface layer of the container, and adding a shadow layer to the surface layer of the container.

3. The method according to claim 2, wherein in the step of highlighting the selected card on the surface layer of the container, when the selected card is clicked by a user through touching or key-press or mouse, highlight animation, magnification animation and shadow animation are played at the same time.

4. The method according to claim 3, further comprising placing the highlighted card in the container.

5. The method according to claim 3, wherein in the step of placing the highlighted card in the container, when the user moves the mouse or key-press or touching away from the selected card, reverse animations of the highlight animation, magnification animation and shadow animation are played to cause the highlighted card to restore original unselected display state.

6. The method according to claim 1, wherein after the step of highlighting the selected card on a surface layer of the container, the method further comprises:
responding to an event of moving the card, calculating a displacement of the card's movement, and moving the card according to the displacement.

7. The method according to claim 6, wherein the method further comprises:
a step of recording a height of the card, a width of the card, a rotation angle relative to a center of the card, coordinates of the center of the card in the container.

8. The method according to claim 7, wherein the calculating a displacement of the card's movement is:
obtaining and recording coordinates of a selected point of the card before and after the card is moved, and calculating the displacement of the card's movement according to the coordinates of the selected point of the card before and after the card is moved.

9. The method according to claim 8, wherein after the moving the card, the method further comprises:
obtaining coordinates of the center of the card before the card is moved, and calculating and recording coordinates of the center of the card after the card is moved according to the coordinates of the selected point of the card before and after the card is moved as well as the coordinates of the center of the card before the card is moved.

10. The method according to claim 1, wherein the method further comprises:
a step of responding to an event of rotating the card, calculating a rotation angle, and rotating the selected card according to the rotation angle.

11. An instant messaging client comprising:
a display module, configured to display information of contacts in the form of cards in a container;
an event response module, configured to respond an event that a card is selected;
a processing module, configured to process the selected card to highlight the selected card on a surface layer of the container which is displayed through the display module.

12. The instant messaging client according to claim 11, wherein the processing module is further configured to change light beam on a surface of the selected card, and/or magnify the selected card according to a predefined magnification, and/or highlight the selected card on the surface layer of the container and add a shadow layer to the surface layer of the container.

13. The instant messaging client according to claim 11, wherein the event response module is further configured to respond to an event of moving the card, the processing module is further configured to calculate a displacement of the card's movement and move the card according to the displacement.

14. The instant messaging client according to claim 13, further comprising a recording module configured to record a height of the card, a width of the card, a rotation angle relative to a center of the card, coordinates of the center of the card in the container.

15. The instant messaging client according to claim 14, wherein the processing module is further configured to obtain coordinates of a selected point of the card before and after the card is moved, and calculate the displacement of the card's movement and coordinates of the center of the card after the card is moved according to the coordinates of the selected point of the card before and after the card is moved.

16. The instant messaging client according to claim 15, wherein the recording module is further configured to record the coordinates of the selected point of the card before and after the card is moved as well as the coordinates of the center of the card before the card is moved.

17. The instant messaging client according to claim 11, wherein the event response module is also configured to respond to an event of rotating the card, the processing module calculates a rotation angle and rotates the selected card according to the rotation angle.

18. A computer storage media for storing computer-executable instructions, the computer-executable instructions being for controlling a computer to execute a method for displaying contacts in an instant messenger, the method comprises:
displaying information of the contacts in the form of cards in a container;
responding to an event that a card is selected; and
highlighting the selected card on a surface layer of the container.
